(19) United States
(12) Patent Application Publication
(10) Pub. No.: US 2025/0346125 A1
(43) Pub. Date: Nov. 13, 2025

(54) MOBILE WORKING MACHINE WITH ENERGY STORAGE MODULE

(71) Applicant: Liebherr-Werk Telfs GmbH, Telfs (AT)

(72) Inventors: Eugen MALLAUN, See (AT); Fabian KRANEBITTER, Oberhofen (AT)

(21) Appl. No.: 19/200,202

(22) Filed: May 6, 2025

(30) Foreign Application Priority Data
May 8, 2024 (DE) 10 2024 112 919.0

(51) Int. Cl. B60L 50/60; B60L 1/00; B60L 50/64; B60L 53/16; B60L 53/80; E02F 3/28; E02F 3/76; E02F 3/80; E02F 9/08; E02F 9/16; E02F 9/18; E02F 9/20; H01M 8/04082; H01M 10/658; H01M 16/00; H01M 50/249

(52) U.S. Cl. CPC B60L 50/60; B60L 1/00; B60L 53/80; H01M 8/04201; H01M 10/658; H01M 16/006; H01M 50/249; B60L 50/64; B60L 53/16; B60L 2200/40; E02F 3/28; E02F 3/7604; E02F 3/80; E02F 9/0891; E02F 9/166; E02F 9/18; E02F 9/205; H01M 2220/20; H01M 2250/20; H01M 2250/402

(57) ABSTRACT

The disclosure relates to a mobile working machine, in particular a bulldozer or crawler loader, comprising a vehicle chassis, an electric drive system for providing a travelling function and/or a working function of the working machine and an energy storage module, which is configured to supply the electric drive system with electrical energy and/or to store electrical energy provided by the electric drive system. According to the disclosure, the energy storage module has bearing elements, via which it is detachably fastened in a module holder of the vehicle chassis, wherein the bearing elements are arranged laterally raised on the energy storage module and essentially at the level of the centre of gravity of the energy storage module.

### CROSS REFERENCE TO RELATED APPLICATION

The present application claims priority to German Patent Application No. 10 2024 112 919.0 filed on May 8, 2024. The entire contents of the above-listed application are hereby incorporated by reference for all purposes.

### TECHNICAL FIELD

The present disclosure relates to a mobile working machine.

### BACKGROUND

Recently, there has been an increasing trend towards the electrification of working machines in order to reduce pollutant emissions and especially CO₂ emissions. Depending on the type and functionality of the working machines, different challenges arise when it comes to electrification. In particular, smaller working machines with high performance requirements, such as bulldozers or crawler loaders, have so far made it difficult to fully electrify such equipment due to the high mass of electrical energy storage systems, the resulting weight distribution of the working machine and the limited installation space.

### SUMMARY

The object of the present disclosure is therefore to overcome the aforementioned hurdles and to enable the electrification of mobile working machines, in particular of machines such as the aforementioned bulldozers or crawler loaders.

According to the disclosure, this object is achieved by a working machine with the features as described herein.

Accordingly, a mobile working machine is proposed, which in particular can be a bulldozer or a crawler loader. The working machine comprises a vehicle chassis, an electric drive system and an energy storage module. The drive system can comprise a plurality of drive units (e.g. electric motors), which in particular can be designed as electric traction motors and/or serve to drive working functions of the working machine, such as the drive of one or more hydraulic pumps or a pump transfer transmission for supplying one or more hydraulic consumers. The energy storage module is configured to supply the electric drive system with electrical energy and/or to store electrical energy provided by the electric drive system, e.g. in a generator mode of at least one traction drive during a braking process (recuperation).

Optionally, it is a fully electric working machine in which not only the working functions but also the chassis are electrically driven. In principle, the working machine can be a semi-autonomous, fully autonomous, remote-controlled or a working machine that can be controlled by an operator from a driver's cab. For this purpose, the working machine can have corresponding sensors and/or cameras to enable partially or fully autonomous working and/or travelling operation or remote control of the working machine. Sensors and/or cameras can also be provided for driver-controlled operation, for example to assist the driver in a work mode and/or to monitor the work mode.

According to the disclosure, the energy storage module has bearing elements, via which it is detachably fastened in a module holder of the vehicle chassis. The energy storage module can therefore be removed from the vehicle chassis and replaced. The detachable connection via the bearing elements can be made using screws, for example.

Such energy storage elements have a considerable dead weight and therefore influence the overall weight distribution of the working machine. Depending on the arrangement and design, this can cause the energy storage module to generate a tilting moment, which can have a negative effect on the driving and working behaviour of the working machine.

To counteract this, the bearing elements are arranged in a raised position on the side of the energy storage module according to the disclosure and not in a lower area or even on the underside. The bearing elements are essentially at the height of the centre of gravity of the energy storage module, such that the energy storage module is mounted stably in the chassis of the working machine and the generation of tilting moments is prevented. This makes it possible to install an energy storage system with a considerable charging capacity, which is accompanied by a corresponding dead weight, in working machines such as bulldozers or crawler loaders, which enables or facilitates their full electrification.

The bearing elements can be located slightly below, slightly above or exactly at the height of the centre of gravity of the energy storage module.

The installation position or the module holder of the energy storage module can be located in front of a driver's cab in the direction of travel, resulting in optimum weight distribution.

The energy storage module may be specifically designed (in terms of mass distribution and bearing position in the vehicle chassis) to optimize the overall weight distribution of the working machine. The basic concept here is not simply to provide an energy storage element for electrical operation, but to use the weight of the energy storage module specifically to optimally balance the working machine and minimize the tilting moments that occur during driving and working operation.

The term “module” is to be interpreted broadly and in the simplest case means that the energy storage module can be removed and installed or replaced. However, an embodiment would also be conceivable in which differently designed energy storage modules (e.g. with different energy storage capacities and/or different additional components) can be optionally installed in the module holder, depending on the requirements and intended use, such that a modular system is created.

In one possible embodiment, the bearing elements are arranged in the centre third of the overall height of the energy storage module. Alternatively or additionally, the bearing elements can be less than a quarter of the total height of the energy storage module away from the centre of gravity of the energy storage module. This results in a suspension close to the centre of mass of the energy storage module, which minimizes the tilting moments generated by the energy storage module.

In another possible embodiment, it is provided that the energy storage module has a housing and the bearing elements are located on the side of the housing. The bearing elements can be arranged symmetrically to a centre plane of the energy storage module, wherein this may coincides with a centre plane or longitudinal axis of the working machine.

In another possible embodiment, it is provided that the energy storage module has exactly four bearing elements. In principle, however, a bearing or suspension can also be provided via fewer than four bearing elements (e.g. three-point bearing) or via more than four bearing elements.

Alternatively or additionally, the bearing elements may comprise damping elements such as rubber-metal bearings or buffers. These decouple the energy storage module from the chassis or the rest of the working machine and thus protect it from external mechanical influences. The bearing elements can therefore also be used for damping or suspension of the energy storage module in addition to the mechanical fastening of the energy storage module in the chassis. The number of damping elements may be equal to or greater than the number of bearing elements.

Alternatively or additionally, the bearing points can be arranged differently to each other in a vertical direction. For example, it is conceivable that the front bearing points are arranged vertically offset relative to the rear bearing points.

In another possible embodiment, it is provided that the energy storage module is thermally insulated. This minimizes thermal effects from the environment. Optionally, the energy storage module can have a cooling device.

In another possible embodiment, it is provided that the energy storage module comprises at least one rechargeable battery and/or at least one battery. For the sake of simplicity, only the term battery is used in the following, but it should be understood to also encompass rechargeable batteries as well as battery stacks and rechargeable battery stacks. Furthermore, a reference to “the battery” should always be understood as “the at least one battery”. The battery of the energy storage module can be designed as a high-voltage battery. The battery can be a rechargeable battery type with different cell chemistries such as lithium-nickel-manganese-cobalt or lithium-iron-phosphate.

In another possible embodiment, the energy storage module comprises a fuel cell (or a fuel cell stack) by means of which the battery can be charged. The fuel tank for supplying the fuel cell (e.g. a hydrogen tank or a methane tank) can also be integrated into the energy storage module. Alternatively or additionally, one or more fuel tanks can be installed at other locations on the working machine and connected to the fuel cell via one or more fuel lines. The use of a fuel cell has the advantage that downtime of the working machine can be minimized during the charging/refuelling process. The charging/refuelling process can be carried out by charging the battery and/or refuelling the fuel tank. The fuel tank optionally has a filler neck that is accessible from the outside. Several fuel cells or fuel cell modules can be installed at different points on the working machine.

In another possible embodiment, additional components are integrated into the energy storage module.

For example, the energy storage module may comprise a battery management or a power distribution system for controlling power flows to and from the energy storage module. Alternatively, the power distribution system could be arranged outside the energy storage module in a separate module or at any other point on the working machine. The power distribution system can comprise a control unit that controls the power flows accordingly.

Alternatively or additionally, the energy storage module may comprise a charging socket to connect an external power supply to the energy storage module and charge an internal battery from outside the working machine. The charging socket can be arranged so that it is easily accessible from outside the working machine, for example, from the ground or from the driver's cab or a working platform arranged in the area of the driver's cab. Alternatively, the charging socket could be arranged separately from the energy storage module at a different location on the working machine.

Alternatively or additionally, the energy storage module may comprise a mechanical isolation device for electrically isolating the energy storage module from a high-voltage system of the working machine, for example by means of a high-voltage battery switch or an electrically actuated high-voltage isolation relay.

Alternatively or additionally, the energy storage module may comprise a firefighting system. The firefighting system can be provided for the energy storage module itself, the remaining components of the working machine or both. In one example, the firefighting system may be one or more tanks containing a fire suppressing agent. Alternatively, the firefighting system may be a heat or smoke detecting device or fire-resistant insulation.

Alternatively or additionally, the energy storage module may comprise a device for suppressing chemical reactions. This device can be provided for the energy storage module itself, the remaining components of the working machine or both. In one example, the device for suppressing chemical reactions may be phase-change materials, thermal fuses, fire-resistant coatings, gas adsorption materials, or pressure relief valves.

In another possible embodiment, it is provided that the working machine comprises at least one pivoted or hinged machine cover, which can be pivoted into an opening position for removing the energy storage module, in which opening position the energy storage module can be removed (e.g. lifted) from the vehicle chassis. The machine cover can be a front part of a main frame of the working machine, which in particular can be tilted forwards (i.e. away from a driver's cab).

The working machine can comprise a plurality of energy storage modules distributed over the machine, such that a plurality of pivoted or otherwise removable covers can be provided to protect the energy storage modules and make them accessible from the outside if necessary (e.g. for maintenance or replacement) or to provide sufficient space for removing the energy storage modules.

In another possible embodiment, the working machine comprises a driver's cab. Optionally, the driver's cab is pivoted and can thus be pivoted or tilted into an opening position for removing the energy storage module, for example towards the rear of the machine. This makes it possible to design the energy storage module to be sufficiently large and thus provide a higher energy storage capacity. On machines with limited installation space, such as bulldozers, the driver's cab can optionally be folded back to create sufficient space for removing and installing the energy storage module.

In addition, a front part of the frame can be pivoted in order to create even more space for removing and installing the energy storage module, for example by pivoting it forwards (i.e. away from the driver's cab).

Optionally, the driver's cab can be locked in a closed or collapsed position. The pivot axis of the driver's cab and/or the aforementioned front part of the frame can be orientated horizontally and perpendicular to the direction of travel or the longitudinal axis of the working machine.

Optionally, the heavy driver's cab can be pivoted by means of at least one actuator, for example by means of one or more hydraulic cylinders. Alternatively or additionally, the aforementioned machine cover can also be pivoted by an actuator or manually.

As already indicated, the working machine can comprise a plurality of energy storage modules distributed across the machine in order to increase the available energy storage capacity. In another possible embodiment, it is therefore provided that the energy storage module is a first energy storage module and the working machine comprises at least one additional energy storage module electrically connected to the first energy storage module and/or to the electric drive system. Optionally, the at least one additional energy storage module is detachably fastened in a module holder of the vehicle chassis or in a module holder formed on another component of the working machine, such that it can be removed and replaced after the life cycle has been completed or in the event of a defect. All energy storage modules are optionally arranged such that there is a good all-round view from the driver's cab.

Optionally, each of the energy storage modules installed in the working machine is arranged, designed and optimized accordingly with regard to the overall mass distribution of the working machine.

At least one additional energy storage module can be arranged in the area of a driver's cab of the working machine, for example to the side of the driver's cab or behind the driver's cab.

Alternatively or additionally, at least one additional energy storage module can be arranged as an additional weight or counterweight at the rear of the working machine. The weight of the energy storage module is therefore used specifically as a rear ballast, resulting in improved balancing of the working machine.

In another possible embodiment, it is envisaged that the working machine is a remotely operable or fully autonomously operable working machine without a driver's cab, wherein an additional energy storage module can be arranged on an upper side of the working machine instead of the driver's cab. In this case, the additional energy storage module can optionally be pivoted (for example towards the rear of the machine) so that it can be tilted into an opening position to remove the first energy storage module. This can optionally be done by means of an actuator (e.g. one or more hydraulic cylinders), but can also be done manually in a smaller design of the further energy storage module.

In another possible embodiment, the working machine comprises a control unit connected to a power distribution system, which control unit is configured to charge the energy storage modules installed in the working machine faster or slower (variation of the charging power) depending on their installation position. Optionally, the control unit is configured to charge energy storage modules that are arranged further inside (i.e. installed deeper in the working machine) and/or that require more complex removal and/or that require movement of other components of the working machine, such as the driver's cab, more slowly, i.e. with reduced charging power. The control unit can be integrated into the aforementioned energy storage module or located elsewhere on the working machine. The control unit can be a machine control unit. The control unit may comprise a processor and a memory storing instructions that are executable by the processor to control operation of the energy storage modules.

The basic concept here is therefore to base the charging strategy on the cost of removing and installing the various energy storage modules. It is well known that faster charging over the operating time leads to a shorter service life of an energy storage element than slower charging. The energy storage modules, which are easier to replace, can therefore be charged faster than energy storage modules that are installed deeper in the working machine or are more complex to replace. The latter are deliberately charged more slowly and are therefore protected so that they need to be replaced less frequently. In one example, a first energy storage module installed at a first distance from the outer surface of the working machine may be charged more slowly than a second energy storage module installed at a second distance from the outer surface of the working machine, where the second distance is less than the first distance. In this way, the energy storage module installed internally may be charged more slowly and therefore have a longer service life than a more accessible energy storage module installed superficially. In another example, a speed of charging the energy storage module may be a function of a determined removal complexity of the energy storage module. That is, energy storage modules requiring more complex removal may be charged more slowly.

In another possible embodiment, it is provided that the working machine is a bulldozer with two laterally arranged crawler carriers (drives), wherein each crawler carrier can be driven separately, for example via at least one drive unit (for example an electric traction motor) of the electric drive system. The crawler undercarriage can be designed as a high drive (delta-shaped drive) or as a low drive (oval-shaped drive). The bulldozer can have additional equipment at the rear, such as a rear scarifier and/or a cable winch. Alternatively or additionally, there may be a counterweight at the rear, which is optionally formed by an additional energy storage module or in which an additional energy storage module is integrated.

The present disclosure also relates to an energy storage module for the working machine according to the disclosure. This can be designed according to any of the embodiments described above. This results in the same advantages and properties as previously described in relation to the working machine according to the disclosure, so a repetitive description is dispensed with.

### BRIEF DESCRIPTION OF THE FIGURES

Further features, details and advantages of the disclosure result from the following exemplary embodiments explained with the help of the figures. In the drawings:

FIG. 1: shows a perspective view of the energy storage module according to the disclosure according to a first exemplary embodiment;

FIG. 2: shows a perspective view of the energy storage module according to the disclosure according to a second exemplary embodiment;

FIG. 3: shows a perspective view of a possible installation position of the energy storage module in an exemplary embodiment of the working machine according to the disclosure;

FIG. 4: shows a side view of an exemplary embodiment of the working machine according to the disclosure with the energy storage module removed;

FIG. 5: shows a side view of another exemplary embodiment of the working machine according to the disclosure with the energy storage module removed; and

FIGS. 6-9: show various exemplary embodiments of the working machine according to the disclosure with different arrangements of additional energy storage modules.

### DETAILED DESCRIPTION

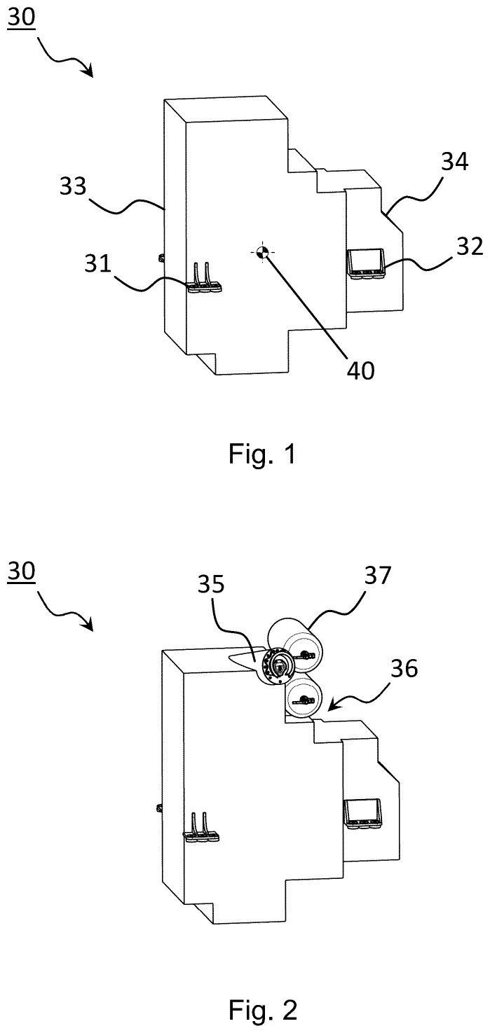

FIG. 1 schematically shows a perspective view of a first exemplary embodiment of the energy storage module 30 according to the disclosure. The energy storage module 30 has a housing 33, which may be a single housing or a housing composed of several sub-housings and, in particular, may be made of metal. The centre of gravity of the energy storage module 30 is designated with the number 40. The energy storage module 30 has an energy storage clement, which may comprise one or more batteries and/or rechargeable batteries (collectively referred to herein as “battery”). This stores electrical energy to supply an electric drive system of the working machine 10 with energy. The electric drive system can comprise one or more electric traction motors, for example to drive a crawler chassis. The electric drive system can comprise additional electrical consumers such as electric drives for machine components, a pump transfer case for driving hydraulic consumers and/or a low-voltage electrical system.

The energy storage module 30 may comprise additional components such as a power distribution system 34 for battery management (control of the energy flows from the energy storage module 30 to the electric drive system and, if necessary, from the electric drive system to the energy storage module 30), which can also have a fuse. In the exemplary embodiment shown in FIG. 1, the power distribution system 34 is arranged in a housing section at the rear (right in FIG. 1) of the energy storage module 30, although in other examples, the arrangement of the power distribution system 34 may vary. The energy storage module 30 can be thermally insulated in order to minimize thermal effects from the environment.

The energy storage module 30 is installed in a module holder of a vehicle chassis of the working machine 10 and suspended via a plurality of bearing elements 31, 32. The latter are arranged laterally raised on the outside of the housing 33 of the energy storage module 30 in order to enable suspension close to the centre of gravity 40 of the energy storage module 30 and thus keep the tilting moment low. In the exemplary embodiment shown in FIG. 1, the energy storage module 30 has front bearing elements 31, which are arranged in the area of the front side (on the left in FIG. 1), and rear bearing elements 32, which can be arranged, for example, on the housing section of the power distribution system 34. In the exemplary embodiment shown, four bearing elements 31, 32 are provided, in particular two front bearing elements 31 and two rear bearing elements 32, which are arranged symmetrically in relation to the longitudinal axis of the vehicle. The exact arrangement and number of bearing elements may vary and depends on the working machine, the available installation space and the desired mass distribution.

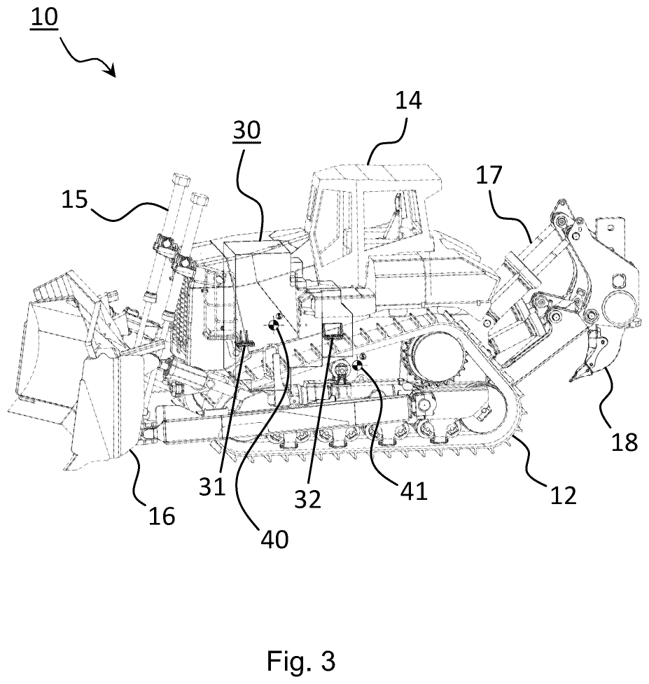

The energy storage module 30 may comprise additional components, as shown schematically in FIG. 2 by means of a second exemplary embodiment. For example, a device for accommodating a charging socket 35 can be arranged on the energy storage module 30 in order to be able to charge its energy storage element externally. For example, a device 37 for fighting and containing fires or other chemical reactions that can occur in energy storage devices can be arranged on the energy storage module 30. This fire-fighting system 37, which may comprise one or more tanks for fire-fighting agents, may be provided for the energy storage module 30 itself and/or for further components of the working machine 10. For example, an isolation device 36 for isolating the energy storage unit of the energy storage module 30 from the machine high-voltage system can be integrated into the energy storage module 30.

The aforementioned additional components do not all have to be present together, but can be integrated into the energy storage module 30 in any combination. Their arrangements are also not limited to the exemplary embodiments shown in FIGS. 1-2, but are only shown as examples.

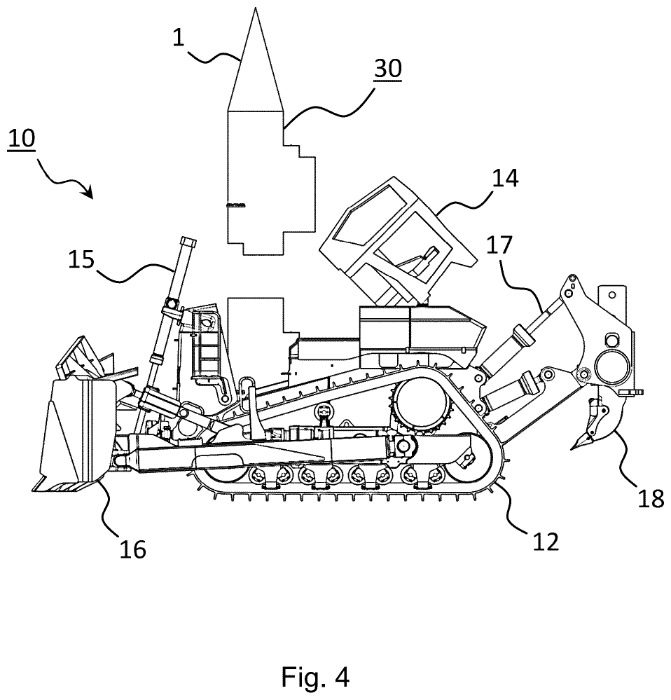

The arrangement and design of the energy storage module 30 in the working machine 10 may serve, among other things, to ideally position the centre of gravity 41 of the working machine 10 (see FIG. 3). This results in improved mass and driving properties of the working machine 10. In addition, the energy storage module 30 should be arranged in such a way that it can be replaced without dismantling essential main components of the working machine 10. This can include, for example, a driver's cab 14 or parts of the main frame.

FIG. 3 shows a perspective view of an exemplary embodiment of the mobile working machine 10 according to the disclosure and a possible installation position of the energy storage module 30. To show the energy storage module more clearly, the other components of the working machine 10 are shown in dashed lines. The exemplary embodiment of the working machine 10 shown is a bulldozer with a crawler chassis comprising two lateral crawler carriers 12 in a high-drive design. In other examples, the working machine 10 could also have a different chassis, for example a low-drive crawler chassis or a wheeled chassis. Each of the crawler chassis 12 can optionally be driven separately. In addition, energy can be absorbed and stored in the drive train and in the energy storage module 30 via the crawler drive and the drive motors in various application scenarios.

The working machine 10 can have a blade or dozer blade 16 arranged on the front of the machine and adjustable via front hydraulic cylinders 15. The working machine 10 can have a rear scarifier 18 at the rear that can be adjusted via hydraulic cylinders 17.

The working machine 10 can be designed for operator-controlled operation and comprise a driver's cab 14 from which the driving and working operation is controlled. Alternatively, the working machine 10 could be designed for remote-controlled or fully autonomous operation and therefore not have a driver's cab (see FIGS. 7-8).

In the exemplary embodiment of FIG. 3, the energy storage module 30 is arranged in the installed state in a module holder of the chassis between the driver's cab 14 and the dozer blade 16 and can be covered and protected by a housing cover of the machine housing. The shape of the energy storage module 30 can be adapted to the available installation space and, in particular, to an optimum position of the overall centre of gravity 41 of the working machine 10. The centre of gravity 41 of the working machine 10 can be located in the area behind the energy storage module 30 and below the driver's cab 14. The centre of gravity 41 of the working machine 10 can be lower than that of the energy storage module 30.

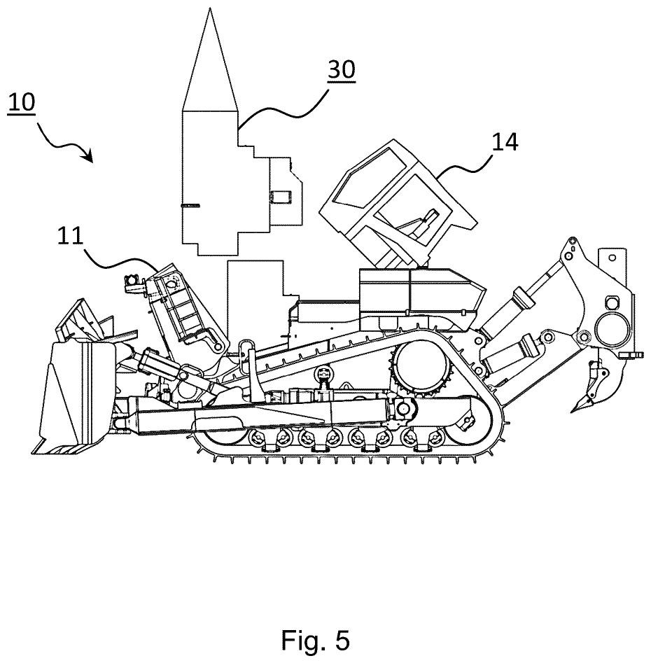

In order to have sufficient space for lifting out the energy storage module 30 during a replacement, it may be provided that the driver's cab 14 is pivotably mounted and can be folded backwards (e.g. mechanically or hydraulically). This is shown in FIG. 4, wherein the energy storage module 30 is shown being lifted out of the vehicle chassis via a slinging means 1 (e.g. a chain or a cable) by a hoist (not shown).

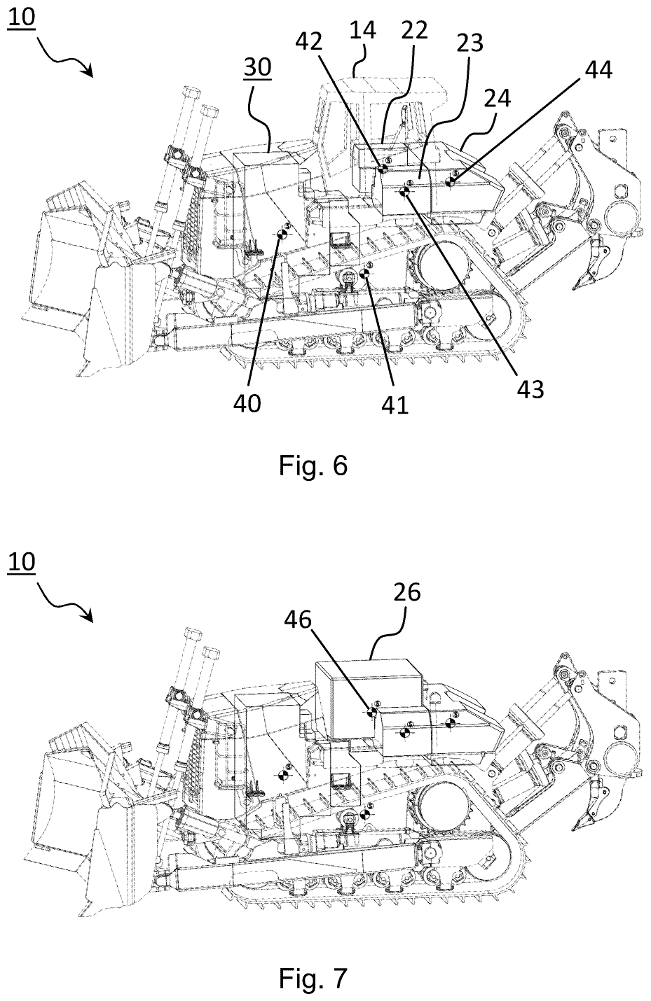

FIG. 5 shows another exemplary embodiment in which a front frame part 11 of the working machine 10, on which the hydraulic cylinders 15 for adjusting the dozer blade 16 can be mounted, can be tilted forwards (e.g. mechanically or hydraulically). This allows the energy storage module 30 to be lifted out diagonally upwards.

FIGS. 4 and 5 also show the energy storage module 30 in its installation position.

Additional energy storage capacity may be required for various applications of the bulldozer or the working machine 10. In addition to the energy storage module 30 (which is referred to below as “first energy storage module 30” for the purpose of clear designation), the working machine 10 can therefore comprise at least one additional energy storage module 22-29 in order to increase the energy storage capacity. The additional energy storage modules 22-29 may be arranged in such a way as to optimize mass distribution and all-round visibility.

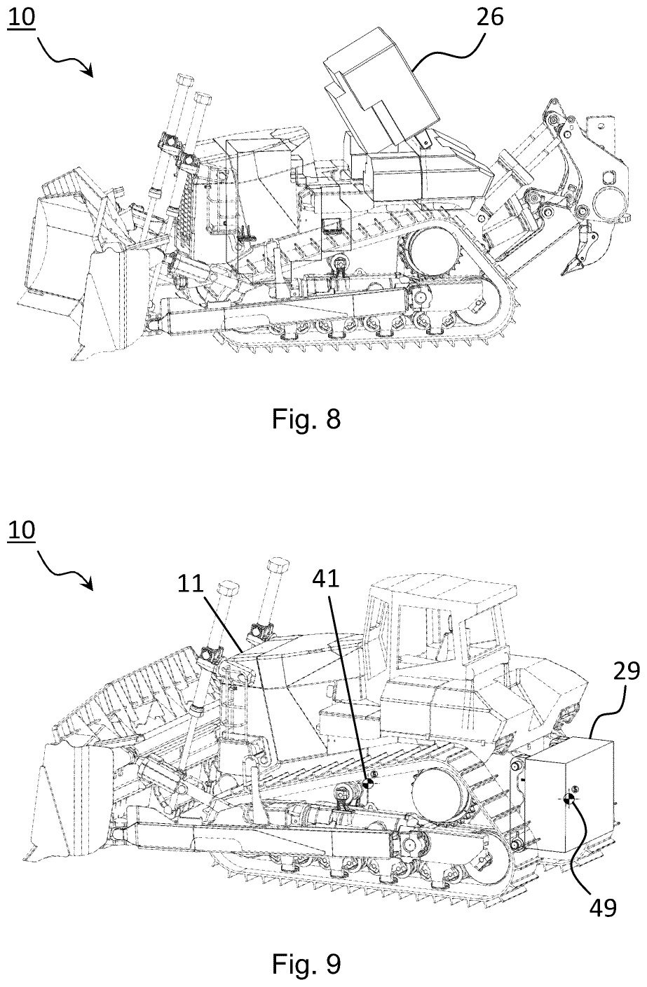

FIG. 6 shows an exemplary embodiment in which three additional energy storage modules 22, 23 and 24 are arranged to the side of and behind the driver's cab 14. Their centres of gravity are designated with the numbers 42, 43 and 44.

FIG. 7 shows another exemplary embodiment in which the working machine 10 is operated remotely or fully autonomously and an additional energy storage module 26 with mass centre of gravity 46 is installed on the working machine 10 instead of the driver's cab 14. This can optionally be surrounded by additional energy storage modules 22, 23, 24.

As shown in FIG. 8, the additional energy storage module 26 provided instead of the driver's cab 14 can be pivoted in order to be tilted backwards (e.g. mechanically or hydraulically) (as in the exemplary embodiment of FIG. 4 with the driver's cab 14) and thereby enable installation and removal of the first energy storage module 30.

FIG. 9 shows another embodiment in which the working machine 10 has an additional energy storage module 29 with a centre of gravity 49, which is mounted as a counterweight at the rear of the working machine 10 instead of the rear scarifier 18. Alternatively, a plurality of energy storage modules can be provided as counterweights.

The additional energy storage modules 22-29 shown in FIGS. 6-9 can be installed in any combination in the working machine 10. Other energy storage modules and/or other installation positions than those shown in the figures are also conceivable. The energy storage modules 30, 22-29 can be connected to each other and to the electric drive system via a high-voltage intermediate circuit.

Depending on the service life of the energy storage elements installed in the various energy storage modules 22-29, 30, which is highly dependent on the charging strategy, it may be necessary to replace the energy storage elements several times during the product life cycle. In the case of large bulldozers (mining dozers) used in opencast mines, for example, an energy storage element may have to be replaced after just one or two years of use in accordance with the current state of the art. This roughly corresponds to an operating time of 5,000 to 10,000 operating hours. Assuming a product service life of 60,000 operating hours, which is quite common, this means that an energy storage element needs to be replaced 5-10 times after the machine has left the production plant. To minimize the amount of work involved, replacement of energy storage elements should be as simple as possible.

For this reason, in an embodiment of the working machine 10 according to the disclosure, the charging strategy is adapted to the replacement effort of the respective energy storage modules 22-29, 30. Those energy storage modules that can be removed and replaced quickly and easily can be charged quickly with high charging power, as this results in a shorter service life and the storage units have to be replaced more often. Those energy storage modules that are integrated deeper into the working machine 10 are charged more slowly in order to protect the energy storage element and maximize its service life. These protected energy storage modules can have a longer service life than the fast-charging storage elements and only need to be replaced every second or third time, for example. The charging strategy can be ensured via a corresponding control unit, which controls the energy flows between the energy storage modules 22-29, 30.

In the exemplary embodiment shown in FIG. 6, for example, it may be provided that the energy storage modules 22, 23, 24 installed further out in the area of the driver's cab 14 are charged more quickly than the first energy storage module 30, which requires more effort to replace.

Another variant of the energy storage module 30 may comprise an integrated battery in combination with hydrogen tanks and an integrated fuel cell. The energy required for the working machine 10 is taken from the battery. In various application scenarios, energy can be absorbed and stored in the drive train and in the battery of the energy storage module 30 via the crawler drive (recuperation mode). In addition, the battery is charged as required using an integrated fuel cell and the necessary hydrogen tanks. This variant has the advantage of minimizing the downtime of the working machine 10 due to the charging/refuelling process. The latter can be achieved by charging the battery and/or refuelling the hydrogen tanks.

The drive shape of the working machine 10 may have an influence on the size, number and arrangement of the energy storage modules 30, 22-29. The weight of the crawler loader 10 can be between 10 and 125 tons.

FIGS. 1-9 are shown approximately to scale. FIGS. 1-9 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of clement may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the terms “approximately,” “substantially,” “esentially,” and “slightly” are construed to mean plus or minus five percent of the range unless otherwise specified.

### LIST OF REFERENCE NUMERALS

1 Slinging means
10 Mobile working machine
11 Cover
12 Crawler chassis
14 Driver's cab
15 Hydraulic cylinder
16 Dozer blade
17 Hydraulic cylinder
18 Rear scarifier
22 Additional energy storage module
23 Additional energy storage module
24 Additional energy storage module
26 Additional energy storage module
29 Additional energy storage module
30 Energy storage module
31 Front bearing element
32 Rear bearing element
33 Housing
34 Power distribution system
40 Centre of gravity of the energy storage module
41 Centre of gravity of the working machine
42 Centre of gravity
43 Centre of gravity
44 Centre of gravity
46 Centre of gravity
49 Centre of gravity

1. A mobile working machine, comprising a vehicle chassis, an electric drive system for providing a travelling function and/or a working function of the mobile working machine and an energy storage module, which is configured to supply the electric drive system with electrical energy and/or to store electrical energy provided by the electric drive system,
wherein
the energy storage module has bearing elements, via which it is detachably fastened in a module holder of the vehicle chassis, wherein the bearing elements are arranged laterally raised on the energy storage module and essentially at a level of a centre of gravity of the energy storage module.

2. The mobile working machine according to claim 1, wherein the bearing elements are arranged in a centre third of a total height of the energy storage module and/or are less than a quarter of the total height away from the centre of gravity of the energy storage module.

3. The mobile working machine according to claim 1, wherein the energy storage module has a housing and the bearing elements are located on a side of the housing.

4. The mobile working machine according to claim 1, wherein the energy storage module has exactly four bearing elements and/or the bearing elements comprise damping elements such as rubber-metal bearings.

5. The mobile working machine according to claim 1, wherein the energy storage module has thermal insulation.

6. The mobile working machine according to claim 1, wherein the energy storage module comprises at least one rechargeable battery and/or at least one battery.

7. The mobile working machine according to claim 6, wherein the energy storage module comprises a fuel cell, by means of which the at least one rechargeable battery and/or the at least one battery can be charged.

8. The mobile working machine according to claim 1, wherein the energy storage module comprises one or more of the following components:
a power distribution system for controlling power flows to and from the energy storage module;
a charging socket for connecting an external power supply to the energy storage module;
a mechanical isolation device for electrically isolating the energy storage module from a high-voltage system of the mobile working machine;
a device for fighting fires and/or suppressing chemical reactions.

9. The mobile working machine according to claim 1, comprising at least one machine cover, which is mounted pivotably and can be pivoted into an opening position for removing the energy storage module, in which opening position the energy storage module can be removed from the vehicle chassis.

10. The mobile working machine according to claim 1, comprising a driver's cab.

11. The mobile working machine according to claim 1, wherein the energy storage module is a first energy storage module and the mobile working machine comprises at least one additional energy storage module, which is electrically connected to the first energy storage module and/or to the electric drive system.

12. The mobile working machine according to claim 11, wherein the mobile working machine is a remote-controlled or fully autonomously operable working machine without a driver's cab, wherein the at least one additional energy storage module is arranged on an upper side of the mobile working machine and is mounted pivotably such that it can be pivoted into an opening position in which the first energy storage module can be removed from the vehicle chassis in order to remove the first energy storage module.

13. The mobile working machine according to claim 11, comprising a control unit that is connected to a power distribution system and is configured to charge the energy storage modules installed in the mobile working machine faster or slower depending on their installation position.

14. The mobile working machine according to claim 1, which is a bulldozer with two laterally arranged crawler carriers, wherein each crawler carrier is driven separately via drive units of the electric drive system, and wherein the bulldozer has a ripper, a winch and/or a weight at a rear.

15. An energy storage module for the mobile working machine according to claim 1.

16. The mobile working machine according to claim 1, wherein the mobile working machine is a bulldozer or crawler loader.

17. The mobile working machine according to claim 7, wherein a fuel tank for the fuel cell is integrated into the energy storage module.

18. The mobile working machine according to claim 10, wherein the driver's cab is mounted pivotably, wherein the mobile working machine further comprises an actuator configured to pivot the driver's cab into an opening position for removing the energy storage module, in which opening position the energy storage module can be removed from the vehicle chassis.

19. The mobile working machine according to claim 11, wherein the at least one additional energy storage module is detachably fastened in a modular holder, wherein the at least one additional energy storage module is arranged in an area of a driver's cab and/or the at least one additional energy storage module is arranged as an additional weight at a rear of the mobile working machine.

20. The mobile working machine according to claim 13, wherein the control unit is configured to charge the energy storage modules that are arranged further inside and/or require more complex removal and/or require movement of other components of the mobile working machine more slowly.
